(19) United States
(12) Patent Application Publication
(10) Pub. No.: US 2012/0076909 A1
(43) Pub. Date: Mar. 29, 2012

(54) GLUTEN-FREE VEGAN EMULSIFICATION AND TEXTURIZATION PROCESS

(76) Inventor: Mary Waldner, Paradise, CA (US)

(21) Appl. No.: 13/097,247

(22) Filed: Apr. 29, 2011

Related U.S. Application Data
(60) Provisional application No. 61/329,423, filed on Apr. 29, 2010.

(51) Int. Cl. A21D 10/00; A21D 13/00; A21D 2/38; A23L 1/307; A23L 1/36

(52) U.S. Cl. 426/550; 426/508; 426/496

(57) ABSTRACT

A substitute emulsifier and texturizer and associated production processes are provided for improved gluten-free and vegan baking. Hydrated chia seeds are used to bind water and emulsify oils in preparing a baked product. The associated production process involves hydrating chia seeds to form a chia seed gel, combining the chia seed gel with a gluten-free flour to make a dough or batter and adding other ingredients as desired for producing a baked product. A variety of baked products can be produced including, for example, pie crusts, breakfast bars, granola bars, cookies, crackers, pretzels, muffins, quick breads, and yeast breads.

### FIELD OF THE INVENTION

The present invention relates generally to gluten-free and vegan baked products and, in particular, to a hydrated chia component that can be combined with gluten-free flours to yield baked products of exceptional quality. The invention also includes process for making such baked products and the resulting products.

### BACKGROUND OF THE INVENTION

Gluten is found in a variety of grains and cereals used in baking, including wheat, barley, and rye. In addition, gluten is known for its ability to bind water, and it is often used as a food additive for flavoring, stabilizing, and thickening a variety of products.

Gluten-free diets are necessary or helpful for people with certain conditions such as celiac disease, gluten intolerance, and certain food allergies such as wheat allergy. Food intolerances encompass a wide range of physiological effects where the body does not tolerate the ingestion of a food, whereas a food allergy is an adverse immune response to a particular food. A gluten-free diet is essential and recognized as the only treatment for those suffering from celiac disease. Those allergic to wheat will be helped by using gluten free foods. Some reports have indicated that a gluten-free diet is useful in preventing and treating a variety of other conditions. Moreover, many people have found gluten-free diets to yield a variety of health benefits or to support a specific lifestyle philosophy such as veganism, wherein one avoids the consumption of all animal products such as meat, fish, dairy, and eggs. Food products that are free of all such animal products may therefore be considered “vegan” products.

Unfortunately, because glutens are so pervasive in food products, it is sometimes difficult to adhere to a strict gluten-free diet. In particular, gluten-free baked product options can be limited because of the glutens present in conventional flours. Moreover, even when gluten-free options can be identified, for some people, they are not equivalent to gluten containing versions of the same products in terms of taste, texture, and dietary satisfaction. In particular gluten-free doughs can be challenging to make since gluten is often a key factor in binding ingredients together and creating a smooth, elastic dough or batter. Frequently, gums, stabilizers, eggs, or extra fats are used to substitute for the qualities that gluten offers. However, these additives may be undesirable or unacceptable for some people, e.g., eggs would be an unacceptable gluten substitute for vegans.

Moreover, there are few resources available to commercial bakers attempting to fill this baked product void. For example, the present inventor has conducted extensive research for guidance as to how to make natural and organic gluten-free, vegan baked products that have the taste and texture of their conventional gluten flour or non-vegan counterparts, and has even contacted the American Institute of Baking for guidance, but was unable to obtain satisfactory information. Accordingly, prior to the development of the invention herein disclosed, the need for these products had been unmet.

### SUMMARY OF THE INVENTION

The present invention is directed to a new, healthier, and otherwise improved substitute emulsifier and texturizer in gluten-free baking, opening up the opportunity to create multiple natural and organic gluten-free and vegan baked goods that are not now available in the marketplace for those who require them or are otherwise of unsuitable quality.

The invention further includes methodology for making baked products using the substitute as well novel baked products. Presently celiacs, those allergic to wheat flours, and vegans are often unable to find suitable substitutes for products made with traditional flours which contain gluten or use animal products. The substitute in accordance with the present invention can be used in a variety of baked products including, for example, pie crusts, breakfast bars, granola bars, cookies, crackers, pretzels, muffins, quick breads, and yeast breads.

The substitute has the added benefit of adding nutritional benefits to the resulting baked product. Specifically, the substitute uses chai seeds in a manner found to yield an excellent substitute for gluten-free baking. Chia seeds are relatively high in protein, and contain healthful omega 3 fatty acids. They are also a source of soluble fiber and it is quite likely that the complex polysaccharides formed from hydrated chia may have immune benefits as do complex polysaccharides from the aloe vera plant, the larch tree, and beneficial probiotic bacteria. See, “Immunomodulating Activity of Arabinogalactan and Fucoidan In Vitro,” Eun-Mi Choi, Ah-Jin Kim, Yeon-O Kim, and Jae-Kwan Hwang, published in the Journal of Medicinal Food, winter 2005, pp 446-453, which is incorporated herein by reference.

The substitute blends in with, binds, emulsifies, and stabilizes the non-traditional ingredients that may be used in making gluten-free, non-dairy, or vegan baked products. Such products may be made with the substitute and gluten-free flours made from brown rice, quinoa, tapioca, nuts, legumes, potatoes, amaranth, and vegetable matter to faun dough that does not separate and that possesses the physical characteristics of traditional flour doughs, such as stickiness, stretch, and structure. Additionally, the resulting baked products approximate the texture and “mouth feel” of conventional gluten flour products, and, in the vernacular of the world of food science, the products have a “good crumb.”

“Good crumb” is a term of trade among bakers and food scientists that refers to a number of attributes that contribute to a good eating quality for baked goods. These attributes include crumb firmness or softness, crumb size, and the openness or compactness of the overall structure of the baked product. As well, crumbs may stick together or fall completely apart. For example, yeast bread has a more open structure, while cookies have a more compact crumb structure. Very hard, crumbly cookies have a poor eating quality, as do those that fall apart when broken, making it difficult to serve and size a bite.

The substitute also yields baked products that caramelize their respective sugars and create the Maillard reaction or “browning” necessary to fulfill the traditional flavor and presentation expectations of baked goods and often even deliver improved taste. Moreover, even when baking with gluten-containing flours, the substitute can be used as a vegan recipe emulsifier or an ingredient that allows fatty ingredients to blend well with higher water content ingredients, thus replacing eggs in doughs or batters.

In accordance with one aspect of the present invention, an emulsification and texturizing agent for use in preparing baked products is formed from whole (unground) chia seeds. The process involve hydrating the chia seeds to provide a hydrated chia seed component and using the Chia seed component to bind water and emulsify oils in preparing a baked product.

The ratio of chia seeds to water is determined in a mixture by the degree of moisture that is necessary to create the dough or batter for any one of the desired baked products including, for example, pie crusts, breakfast bars, granola bars, cookies, crackers, pretzels, muffins, quick breads, and yeast breads.

The step of hydrating preferably includes creating a mixture of about 10%-20% chia seeds and 80%-90% water by weight and allowing the mixture to stand a length of time so that the water is absorbed by the seeds. Assuming a 250 gallon vat holding 200 gallons of water weighing 8.35 lbs per gallon, an 85%/15% mixture would contain 294.5 pounds of chia seeds. It is expected that different baked goods will require different amounts of moisture and therefore different ratios of chia to water in hydration and/or different hydration times or other parameters. Chia seeds have been known to absorb from 12 to 16 times their weight, while in the model system herein presented, the chia seeds are generally allowed to hydrate to possibly one-third or one-half their maximum possible levels of hydration. In a preferred embodiment, the chia/water blend acts as both a water binding agent, and an emulsifier, and it acts to stabilize the water in the system. Both the stabilization and the water binding are believed to be made possible by the polysaccharide network that is formed and optimized during the hydration of the chia seeds under this invention. The phenomenon associated with polysaccharides is discussed in Polysaccharides: Structural Diversity and Functional Versatility, by Severian Dumitriu. Monticello, N.Y.: Marcel Dekker, Inc., 2^{nd} Edition, 1998, page 302 et seg., is incorporated herein by reference. The ratio of chia seed to water may be determined based on the amount of moisture that is needed in the final dough or batter. Baked products that require a high level of moisture will generally utilize greater amounts of hydrated chia to ensure adequate water binding capacity, while those products that require less moisture will involve less hydrated chia.

Specifically, the mixture is preferably allowed to stand at a temperature of between about 13° C.-21° C. for a period of at least about 30 minutes so as to form a thickened gel. This is preferably done in a low light environment to prolong the integrity of the chia gel. It is believed that ultra-violet light accelerates the hydration process, ages the gel, and eventually causes the breakdown of the substitute gel. Exposure to light may have a detrimental effect on the polysaccharide gel structure, as bright light can have negative effects on many ingredients and chemical reactions in food products.

The invention further encompasses use of the noted substitute as an emulsifier for use in preparing baked products by the process described above, and the discovery and subsequent development of use of the substitute as a solution for gluten-free and vegan baking formulations. Gluten emulsification involves a molecule structure that allows oil and water molecules to be bound together. In the context of the present invention, the substitute provides a properly balanced gel that increases the ability of the gluten-free flour to bind up water in its system, and allows it to emulsify the oils in the system. This emulsification capacity is not believed to be exist in gluten free flours but for the invention disclosed in this patent. In this regard, emulsification capacity refers to the ability of system to emulsify or take on oil. It is the maximum of oil that may be emulsified before the emulsion “breaks” or allows separation. Thus, in gluten-free, egg-free, or dairy-free baking, where “emulsification” in its traditional sense of binding oil and water together does not occur with the same molecular structure, the chia seed component effects a gluten-free emulsification. This invention, in virtue of its ability to emulsify, allows traditional gluten flour baking recipes to be prepared. In accordance with a still further aspect of the present invention, a novel gluten-free dough or batter and a novel gluten-free baked product are provided. In either case, the dough/batter or (collectively, the “article”) baked product includes a hydrated chia seed component, (e.g., prepared as described above) and a gluten free flour. The gluten free flour may be made from one or more of the following: of brown rice, quinoa, tapioca, nuts, legumes, potatoes, amaranth and vegetable matter. The article may further include a stabilizing ingredient such as xanthan gum or rice bran extract. In preferred formulations, the article is a vegan product.

### BRIEF DESCRIPTION OF THE DRAWING

For a more complete understanding of the present invention, reference is now made to the following detained description, taken in conjunction with the drawing, in which:

FIG. 1 is a flow chart illustrating a process for making a baked product using a hydrated chia seed component for emulsification and texturization in accordance with the present invention.

### DETAILED DESCRIPTION

In the following description, the invention is set forth in the context of using a hydrated chai seed component to make a novel dough or batter that can then be combined with other ingredients as called for by a particular recipe, and can generally be used in a manner anologans to conventional doughs or batters, to make a baked product.

In particular, the invention is described below in relation to making high quality products that are both vegan and gluten-free products. This has been particularly challenging, if not impossible, prior to this invention and is a particularly advantageous application to the present invention. However, as noted above, the hydrated chia component can also be used in vegan, gluten-containing formulations, non-vegan, gluten free formulations, or other formulations in accordance with the present invention. Accordingly, the following description should be understood as exemplifying a particularly beneficial implementation of the invention and not by way of limitation.

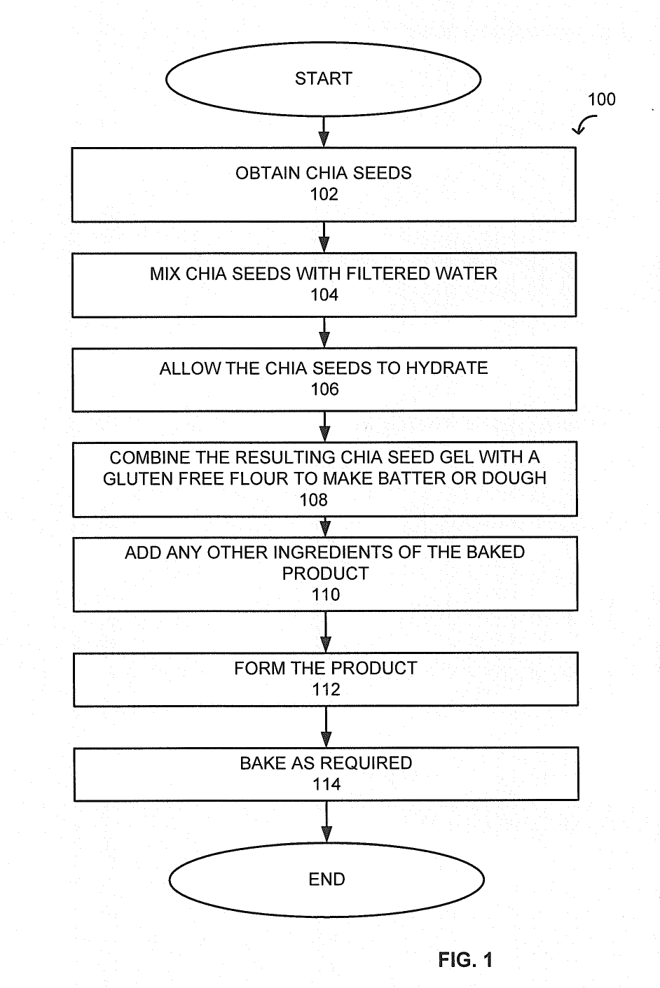

A presently preferred process, suitable for industrial scale baking operations, for forming the chia seed component will now be described in more detail with reference to the flow chart of FIG. 1. It should be appreciated that the invention is not limited to the specific process set forth below.

The illustrated process (100) is initiated by obtaining (102) chia seeds. Salvia hispanica, commonly known as Chia, is a species of flowering plants in the mint family, Lamiaceae. The correct proportions of chia seeds and filtered water are mixed (104) a clean mixing vat. It is noted that the process scales to vat sizes suitable for industrial baking operations. Good results have been obtained for the model system with a mixture of about 15% chia seed and 85% filtered water by weight. However, a higher or lower percentage of water can be used, or the hydrations process time and other parameters can be varied, depending on the need for drier or wetter dough. The mixture can be gently agitated, e.g., with an automated industrial mixer that may be integrated into the vat system or a separate mixer until there are no visible clumps of chia seeds. The chia seeds are then allowed to hydrate. Preferably, the mixture is then placed out of direct sunlight, for example, in a low light environment during hydration. In this regard, the mixture may remain in the enclosed vat during hydration. Preferably, cool water is used (between about 13° C.-21° C.) and the mixture is hydrated in the same temperature range for at least about 30 minutes.

Chia is highly hydrophilic. Water begins absorbing into the chia seeds quickly, for example, within about 10 minutes. For present purposes, the mixture is allowed to stand until the mixture creates a mucilaginous gel. Chia seeds are very small, generally smaller than sesame seeds, and they are generally speckled gray, with some seeds in both the black and white range. The mixture of the chia/water evidences a grayish color, and finally makes a semi-transparent gel over a period of about 30 minutes. Most of the initial thickening and hydration occurs over the first 5-10 minutes and seems to reach an optimal thickness use in variety of baked products (e.g., crackers or cookies) by about 30 minutes. Preferably, the mixture then has the mouth feel of a jam with some seeds, i.e., it is mucilaginous and textured. The precise texture of the gel and water content, as noted above, can be varied to provide different characteristics to the resulting batter or dough. The ratio of the chia/water may vary, depending on the moisture content desired in the resulting dough. Pie crust, being a relatively dry dough product may result from a chia/water ratio that is less hydrated than one designed for cookies. For example, the mixture may stand for three hours or even longer before being incorporated into a baked product. After that length of time, as the soluble fiber in the chia seeds dissolves, the chia gel begins to break down or become over-hydrated and lose its coherence and properties as a substitute emulsification and texturization component.

In any respective instance, break-down of the chia gel may occur after a certain maximum amount of water has been absorbed by the chia seeds. Therefore in making a dryer baked product (e.g.,) a pie crust as opposed to a moister baked product (e.g.) a muffin the length of hydration time may be greatly altered to ensure that the chia seeds do not over-hydrate or cause the ability of the chia mixture to emulsify or to bind water to decline.

Once the balance of hydration time and the ratio of chia seeds to water have been properly established to bind the water within the system and to emulsify the oil within the recipe, the resulting chia seed gel product is then used as an emulsifier and texturizer in a baked product. Specifically, the chia seed gel product can be combined (108) with other ingredients to make a gluten-free or vegan batter or dough. Though the exact recipe will vary, these other ingredients will typically include flours made with brown rice, quinoa, nuts, legumes, potatoes, tapioca, and amaranth or powdered vegetable matter. These ingredients can be mixed in a suitable vat to form a batter of the desired consistency. Other ingredients may be added (110) as required by the particular recipe, and the resulting dough product is formed (112) and baking (114).

More specifically, the chia seed gel can be used in the same manner as gums, eggs, and extra fats that are conventionally substituted for the qualities that gluten offers. It is postulated that the chia gel acts as an emulsifier in these dough systems. In other words, the gel may be actually allowing the hydrophilic (water-loving) ingredients to blend well with the lipophilic (fats and fat-loving ingredients). This is how a conventional emulsifier acts. Conventional emulsifiers act by allowing two immiscible liquids to mix together in what is called a colloid. Convention baking emulsifiers have a lipophilic end and a hydrophilic end that effects the emulsification of oil and water. In each case, in conventional emulsification or gluten-free vegan emulsification in accordance with the present invention, the “emulsifier” brings the water and oil together and keeps them from separating for a time period sufficient for forming the desired baked product. That is, the dough or batter is typically combined with other ingredients of a recipe (e.g., sugars, flavorings and the like) and then formed to the desired size and shape for baking.

For example, such forming may involve use of a mold (e.g., in the case of bread of pie crust) or may involve placing dough on a baking sheet (e.g., in the case of cookies or crackers). The batter or dough provided in accordance with the present invention can keep the oil and water from separating while the product is thus formed and as baking is initiated. The product will then generally undergo structural changes during baking that further stabilizes the product.

Notably, the inventor performed an experiment deigned to assess the emulsification capacity of the chia seed mixture. The experiment tested the mixture by mixing small amounts of oil with the chia water as though to make a traditional egg yoke and oil mayonnaise. The resulting product was a stable mayonnaise that could be used in place of an egg-based mayonnaise. The chia seed mixture effectively emulsified the oil into a creamy mixture.

Importantly, it has been found that conventional doughs and batters generally gluten-free lack such stability over time and during the manufacturing process. Research and experimentation suggest that the stability of the dough or batter is in accordance with the present invention, is negatively impacted by heat, undue agitation, and time. Under the influence of these factors, the dough or batter begins to become unstable, and it de-hydrates or begins to release water through syneresis much as yogurt can de-hydrate and begin to pool water at the top of the mixture. Similarly, traditional emulsification can also become unstable when fat molecules reform as a result of coalescence or by creaming or rising to the surface.

In addition or possibly as a primary mode of action, the chia/gel blend is sequestering the water in the system and binding it to allow final stability in the dough. This is similar to how a gum or stabilizer (hydrocolloid gums and starches are stabilizers that act like emulsifiers to help to mix non-homogenous ingredients in a food system to provide stability) would work—the chia gel binds the water in a system so that it is less mobile and subject to subsequent reaction or syneresis (Syneresis is the expulsion of liquid from a gel as it ages, as the mucilaginous material increases in the gel it “squeezes” the water out of the system) from the system. The polysaccharide network of the chia gel is believed to bind the water into the system and with the oils forms a colloid that keeps the water and oil from separating. The network acts like a hydrocolloid that mixes non-homogenous ingredients in a food system to provide stability.

The gluten structure in conventional gluten dough, once hydrated, provides an elastic network to give the dough structure. As well, with the chia gel of the present invention, structure is provided by the chia polysaccharide network. This network, optionally with the addition of gums such as xanthan gum and rice bran extract, provides the structure necessary to fortify even non-cereal or grass grains such as amaranth and quinoa, (cereal grains, such as barley, wheat, corn, and millet are from the botanical family known as Poaceae, which is a grass family wherein amaranth and quinoa are non-cereal grains that are not part of the grass family, but are more related to spinach and other vegetable). grains which lack the proteins such as glutenin and gliadin that are found in wheat flours. It is the hydration of the proteins in wheat and their interaction with starches in the dough matrix that provides the structure of traditional gluten dough. In gluten-free dough in accordance with the present invention, this structure is created by the polysaccharides, and in some cases fortified with selected gums. The chia/gel works synergistically with gum ingredients in a gluten-free system in accordance with the present invention. These might include xanthan or other gums and rice brand extract to substitute in gluten-free systems for the “structure” that gluten provides in conventional baking systems. It will be appreciated that the chia seed gel is high in omega-3 fatty acids, fiber, protein, and calcium and thus provides a healthier alternative that has also been found to provide baked products of outstanding taste and texture.

As noted above, the chia seed gel product can also be used as a vegan emulsifier and texturizer, replacing eggs in doughs or batters when baking with gluten-containing flours. The invention thus allows industrial baking operations to get a good crumb structure out of a gluten-free batter and the right mouth feel. Mouth feel refers to the tactile sensations in the mouth, such as creaminess or smoothness that characterizes flavor in the resulting baked products. In addition, for a product such as a breakfast bar, chia might be added as the last ingredient so as not to allow very much hydration of the seed at all, but so that it can provide texture.

This invention is remarkable in that it emulsifies replacing eggs, binds up water replacing gluten, and stabilizes gluten-free baked products in many cases, replacing gums and stabilizers. In this respect, this invention is a significant substitute for eggs, gluten-bearing grains, and in many cases gums and stabilizers in bakery products. In any case, the chia seed gel can be used in producing a variety of baked goods including any of the examples noted above. This invention allows the creation of new doughs with non-traditional flour ingredients that reproduce the characteristic flavors and the physical and the natural qualities of traditional flours containing gluten, thus making gluten-free, wheat-free, and vegan or dairy-free baking possible, and on an industrialized level.

What is claimed:

1. A method for use in making baked products, comprising the steps of:
hydrating chia seeds to obtain a hydrated chia seed component; and
using the chia seed component as an emulsifier and texturizer in preparing a baked product.

2. A method of claim 1, wherein said step of hydrating comprises forming a mixture of about 10-20% whole (unground) chia seeds and 80-90% water by weight and allowing the mixture to stand a length of time so that water is absorbed by the seeds.

3. A method of claim 2, wherein said step of hydrating comprises allowing the mixture to stand at a temperature between about 13° C. and 21° C. for at least about 30 minutes.

4. A method of claim 3, wherein said step of hydrating includes allowing the mixture to stand in a minimal light environment.

5. A method as set forth in claim 1, further comprising the step of combining the component with gluten-free flour ingredients to create a dough.

6. A method as set forth in claim 5, wherein said dough comprises a emulsification wherein water is sequestered in said emulsification, substantially free from pooling, for a time period sufficient for formation of said baked product.

7. A method as set forth in claim 1, wherein said chia seed component comprises a gel upon hydration.

8. A method as set forth in claim 7, wherein said gel comprises a polysaccharide network that allows for water binding, texturization and emulsification within gluten-free or vegan dough products.

9. A method as set forth in claim 7 wherein said gel comprises a hydrocolloid that acts as an emulsifier to combine oil and water and prevent their separation for a time period sufficient for the formation of gluten-free or vegan baked products.

10. A method as set forth in claim 5, further comprising the step of combining said dough with stabilizing ingredients to provide a desired structure for gluten-free or vegan baking.

11. A gluten-free baked product formed by the process of any one of claims 1-10.

12. A vegan baked product as formed by the process of any one of claims 1-10.

13. A method as set forth in claim 1, further comprising the step of combining the component with gluten-free flour ingredients to produce a vegan, gluten-free baked product.

14. A dough, batter or baked product (“article’), comprising:
hydrated chia seeds; and
gluten-free flour.

15. An article as set forth in claim 14, wherein said gluten-free flour comprises at least one of brown rice, quinoa, tapioca, nuts, legumes, potatoes, amaranth and vegetable matter.

16. An article as set forth in claim 14, further comprising a stabilizing ingredient.

17. An article as set forth in claim 14, wherein said stabilizing ingredient comprises one of xanthan gum and rice bran extract.

18. An article as set forth in claim 14, wherein said baked product is a vegan product.
